(19) United States
(12) Patent Application Publication
(10) Pub. No.: US 2011/0141657 A1
(43) Pub. Date: Jun. 16, 2011

(54) CONDUCTIVE PASTE COMPOUND FOR EXTERNAL ELECTRODE, MULTILAYER CERAMIC CAPACITOR INCLUDING THE SAME, AND MANUFACTURING METHOD THEREOF

(75) Inventors: Byung Jun JEON, Seoul (KR); Byung Gyun Kim, Jinhae (KR); Myung Jun Park, Suwon (KR); Hyun Hee Gu, Seongnam (KR); Chang Hoon Kim, Yongin (KR); Kyu Ha Lee, Suwon (KR)

(73) Assignee: SAMSUNG ELECTRO-MECHANICS CO., LTD.

(21) Appl. No.: 12/945,263

(22) Filed: Nov. 12, 2010

(30) Foreign Application Priority Data
Dec. 14, 2009 (KR) 10-2009-0124123

(51) Int. Cl. H01G 4/12; B29C 65/02; H01B 1/02

(52) U.S. Cl. 361/321.1; 156/89.12; 252/512; 252/513

(57) ABSTRACT

Provided are a conductive paste for an external electrode, a multilayer ceramic capacitor including the same, and a manufacturing method thereof. The conductive paste compound for an external electrode includes a first powder and a second powder. The first powder includes copper and has a mean grain size of 3 μm or less, and the second powder has a lower diffusion speed and a higher melting point than the copper and has a mean grain size of 180 nm or less.

### CROSS-REFERENCE TO RELATED APPLICATIONS

This application claims the priority of Korean Patent Application No. 10-2009-0124123 filed on Dec. 14, 2009, in the Korean Intellectual Property Office, the disclosure of which is incorporated herein by reference.

### BACKGROUND OF THE INVENTION

1. Field of the Invention

The present invention relates to a conductive paste compound for an external electrode, a multilayer ceramic capacitor including the same, and a manufacturing method thereof, and more particularly, to a conductive paste compound for an external electrode, which is capable of reducing a radial crack and blister occurrence rate, a multilayer ceramic capacitor including the same, and a manufacturing method thereof.

2. Description of the Related Art

In general, a ceramic electronic component using a ceramic material, for example, a capacitor, an inductor, a piezoelectric device, a varistor, or a thermistor, includes a ceramic body, an internal electrode provided inside the ceramic body, and an external electrode provided on the ceramic body to contact the internal electrode.

As one of ceramic electronic components, a multilayer ceramic capacitor includes a plurality of laminated dielectric layers, internal electrodes disposed to face each other, with the dielectric layer interposed therebetween, and external electrodes electrically connected to the internal electrodes.

Multilayer ceramic capacitors are being widely used in mobile communications devices, such as laptop computers, PDAs mobile phones and the like, due to their small size, high capacity and ease of mounting.

Recently, as electronic products have become compact and multi-functional, chip components have also tended to become compact and multi-functional. Following this trend, a multilayer ceramic capacitor is required to be smaller than ever before, but to have a high capacity.

As for a general method of manufacturing a multilayer ceramic capacitor, ceramic green sheets are manufactured and a conductive paste is printed on the ceramic green sheets to thereby form inner electrode layers. Tens to hundreds of such ceramic green sheets, provided with the inner electrode layers, are then laminated to thereby produce a green ceramic laminate. Thereafter, the green ceramic laminate is pressed at high pressure and high temperature and subsequently cut into green chips. Thereafter, the green chip is subjected to plasticizing, sintering and polishing processes, and external electrodes are then formed thereon, thereby completing a multilayer ceramic capacitor.

As the multilayer ceramic capacitor has recently become smaller in size and higher in capacitance, many attempts have been made to manufacture a thin and multilayer ceramic body. However, as the ceramic body has become thin and multilayered, defects such as a radial crack and a blister are generated, causing the degradation in the reliability of a multilayer ceramic capacitor.

### SUMMARY OF THE INVENTION

An aspect of the present invention provides a conductive paste compound for an external electrode, which is capable of reducing a radial crack and blister occurrence rate, a multilayer ceramic capacitor including the same, and a manufacturing method thereof.

According to an aspect of the present invention, there is provided a conductive paste compound for an external electrode, including: a first powder including copper and having a mean grain size of 3 μm or less; and a second powder having a lower diffusion speed and a higher melting point than the copper and having a mean grain size of 180 nm or less.

The second powder may include one or more material selected from the group consisting of nickel, cobalt, iron, and titanium.

The second powder may be a powder type, an alloy type of the second powder and the copper, or a core-shell type where the copper is coated with the second powder.

The second powder may be 0.01 to 30 wt % with respect to the first powder.

According to another aspect of the present invention, there is provided a multilayer ceramic capacitor including: a sintered ceramic body; a plurality of first and second internal electrodes provided inside the sintered ceramic body, the first and second internal electrodes having ends being alternately and respectively exposed to sides of the sintered ceramic body; and first and second external electrodes provided inside the sintered ceramic body and electrically connected to the first and second internal electrodes, respectively, wherein the first and second external electrodes are obtained by sintering a conductive paste which includes a first powder containing copper and having a mean grain size of 3 μm or less, and a second powder having a lower diffusion speed and a higher melting point than the copper and having a mean grain size of 180 nm or less, and the first powder and the second powder form an isomorphous solid solution, and of which the porosity is 0.01% to 2.0%.

The second powder may include one or more material selected from the group consisting of nickel, cobalt, iron, and titanium.

The second powder may be a powder type, an alloy type of the second powder and the copper, or a core-shell type where the copper is coated with the second powder.

The second powder may be 0.01 to 30 wt % with respect to the first powder.

According to another aspect of the present invention, there is provided a method for manufacturing a multilayer ceramic capacitor, including: preparing a plurality of ceramic green sheets; forming first and second internal electrode patterns on the ceramic green sheets; forming a multilayer ceramic body by laminating the ceramic green sheets where the first and second internal electrode patterns are formed; forming a sintered ceramic body by cutting the multilayer ceramic body such that ends of the first and second internal electrode patterns are alternately and respectively exposed, and sintering the cut multilayer ceramic body; forming first and second external electrode patterns by using a conductive paste for an external electrode, such that the first and second external electrode patterns are electrically connected to the sides of the sintered ceramic body, wherein the conductive paste for the external electrodes includes a first powder containing copper and having a mean grain size of 3 μm or less, and a second powder having a lower diffusion speed and a higher melting point than the copper and having a mean grain size of 180 nm or less; and sintering the first and second external electrode patterns to form first and second external electrodes.

The forming of the first and second external electrodes may be performed at a temperature of 600 to 900° C.

The second powder may include one or more material selected from the group consisting of nickel, cobalt, iron, and titanium.

The second powder may be a powder type, an alloy type of the second powder and the copper, or a core-shell type where the copper is coated with the second powder.

The second powder may be 0.01 to 30 wt % with respect to the first powder.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a schematic perspective view of a multilayer ceramic capacitor according to an embodiment of the present invention, FIG. 1B is a schematic cross-sectional view taken along line A-A′ of FIG. 1A, and FIG. 1C is a schematic cross-sectional view taken along line B-B′;

FIG. 2 is a sintering shrinkage graph of a conductive paste compound for an external electrode according to an embodiment of the present invention;

FIG. 3 is a schematic view illustrating a sintering behavior of the conductive paste compound for an external electrode according to an embodiment of the present invention; and

FIG. 4 is a graph showing blister occurrence rates in an embodiment and a comparative example.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and thus their description will be omitted.

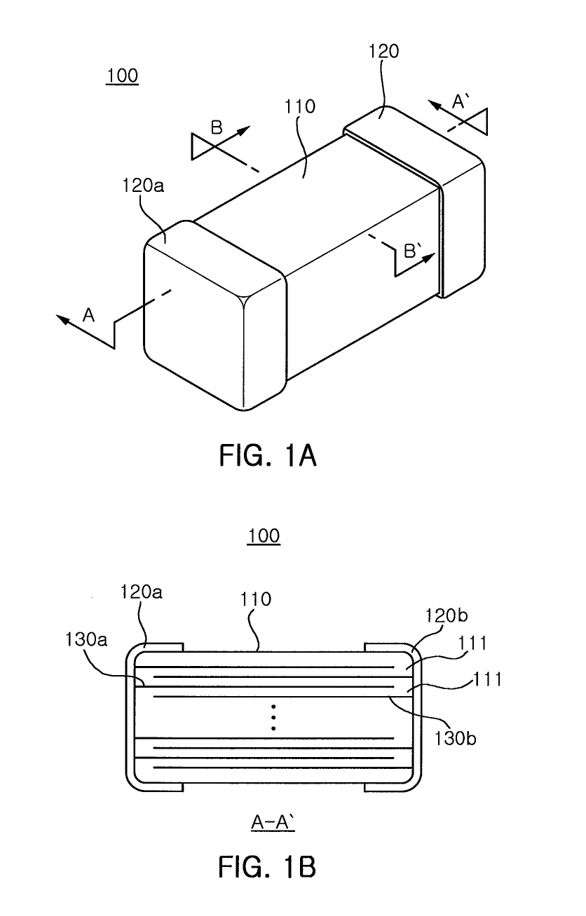

FIG. 1A is a schematic perspective view of a multilayer ceramic capacitor according to an embodiment of the present invention, FIG. 1B is a schematic cross-sectional view taken along line A-A′ of FIG. 1A, and FIG. 10 is a schematic cross-sectional view taken along line B-B′.

Referring to FIGS. 1A to 1C, a multilayer ceramic capacitor 100 according to an embodiment of the present invention includes a sintered ceramic body 110, first and second internal electrodes 130a and 130b provided inside the sintered ceramic body 110, and first and second external electrodes 120a and 120b electrically connected to the first and second internal electrodes 130a and 130b.

The sintered ceramic body 110 is formed by laminating a plurality of ceramic dielectric layers 111 and sintering the laminated ceramic dielectric layers 111. The ceramic dielectric layers 111 are integrated to the extent that boundaries between the adjacent dielectric layers may be difficult to identify.

The ceramic dielectric layers 111 may be formed of a ceramic material having high permittivity. For example, the ceramic dielectric layers 111 may be formed of, but are not limited to, a barium titanate (BaTiO₃)-based material, a lead complex perovskite-based material, or a strontium titanate (SrTiO₃)-based material.

The first and second internal electrodes 130a and 130b are formed between the dielectric layers in the process of laminating the plurality of ceramic dielectric layers 111. The first and second internal electrodes 130a and 130b are formed inside the sintered ceramic body by the sintering, with the dielectric layer interposed therebetween.

The first and second internal electrodes 130a and 130b are a pair of electrodes having different polarities. The first and second internal electrodes 130a and 130b are disposed to face each other along a direction of lamination of the dielectric layers 111, and are electrically insulated from each other by the dielectric layers 111.

Ends of the first and second internal electrodes 130a and 130b are alternately and respectively exposed to both sides of the sintered ceramic body 110. The exposed ends of the first and second internal electrodes 130a and 130b are electrically connected to the first and second external electrodes, respectively.

When a predetermined voltage is applied to the first and second external electrodes 120a and 120b, electric charges are accumulated between the first and second internal electrodes 130a and 130b which face each other. The static capacitance of the multilayer ceramic capacitor is in proportion to the areas of the first and second internal electrodes 130a and 130b which face each other.

The first and second internal electrodes 130a and 130b are formed of a conductive metal. For example, the first and second internal electrodes 130a and 130b may be formed of Ni or Ni alloy. The Ni alloy may include Mn, Cr, Co, or Al together with Ni.

The first and second external electrodes 120a and 120b are formed by sintering a conductive paste for an external electrode. The conductive paste for an external electrode includes a first powder containing copper and having a mean grain size of 3 μm or less, and a second powder having a lower diffusion speed and a higher melting point than copper and having a mean grain size of 180 nm or less.

According to an embodiment of the present invention, the first and second external electrodes 120a and 120b include copper as a main component. The first and second external electrodes 120a and 120b include a copper powder having a mean grain size of 3 μm or less and have a porosity of about 0.01 to 2.0%. Thus, the first and second external electrodes 120a and 120b have an excellent densification and an excellent contact characteristic with the internal electrodes.

In general, since a fine copper powder has a fast sintering initiation and sintering speed, it is difficult to exhaust gas generated during the sintering of the electrodes. Thus, a blister defect may be generated in a contact region between the sintered ceramic body 110 and the first and second external electrodes 120a and 120b.

In addition, when connecting the first and second internal electrodes 130a and 130b to the first and second external electrodes 120a and 120b, the diffusion speed of the copper powder included in the conductive paste for an external electrode is higher than that of the nickel component included in the internal electrodes 120a and 120b. Hence, the diffusion from the external electrodes to the internal electrodes dominantly occurs and the volumes of the internal electrodes increase. Consequently, stress is applied to the dielectric layers 111, which may cause a radial crack as illustrated in FIG. 1C. If the radial crack generated at the end of the chip progresses to the inside of the chip, the reliability of the multilayer ceramic capacitor is degraded.

Furthermore, an isomorphous solid solution including the copper and the second powder is generated during the sintering of the electrodes by adding the second powder to the conductive paste for an external electrode, wherein the second powder has a lower diffusion speed and a lower melting point than the copper and has a mean grain size of 180 nm or less. The sintering temperature of the isomorphous solid solution including the copper and the second powder is higher than the copper, and thus, the sintering speed is controlled.

Since the sintering speed of the external electrode becomes slow and the sintering temperature is increased, a blister occurrence rate may be lowered. Moreover, since the diffusion from the external electrodes to the internal electrodes is suppressed, a radial crack occurrence rate by the volume expansion of the internal electrodes is lowered.

Hereinafter, a method for manufacturing a multilayer ceramic capacitor according to an embodiment of the present invention will be described.

First, a plurality of ceramic green sheets are prepared. Specifically, a slurry is formed by mixing a ceramic powder, a binder, and a solvent, and the slurry is made into a sheet having a thickness of several μm by a doctor blade method.

Then, a paste for an internal electrode is coated on the ceramic green sheets to form first and second internal electrode patterns.

The first and second internal electrode patterns may be formed by a screen printing process. The paste for an internal electrode may be formed by dispersing a Ni or Ni alloy powder into an organic binder and an organic solvent. The Ni alloy may include Mn, Cr, Co, or Al together with Ni.

The organic binder may use a binder known in the art to which the invention pertains. For example, the organic binder may use, but is not limited to, a cellulose-based resin, an epoxy resin, an aryl resin, an acryl resin, a phenol-formaldehyde resin, an unsaturated polyester resin, a polycarbonate resin, a polyamide resin, a polyimide resin, an alkyd resin, and a rosin ester.

Furthermore, the organic solvent may also use an organic solvent known in the art to which the invention pertains. For example, the organic solvent may use, but is not limited to, butyl carbitol, butyl carbitol acetate, turpentine oil, α-terebineol, ethyl cellosolve, and butyl phthalate.

Next, the ceramic green sheets in which the first and second internal electrode patterns are formed are laminated and pressed in a lamination direction to pressurize the laminated ceramic green sheets and the paste for the internal electrodes. In this way, a multilayer ceramic body in which the ceramic green sheets and the paste for the internal electrode are alternately laminated is manufactured.

Next, the multilayer ceramic body is cut to form a chip in each region corresponding to a single capacitor. In this case, the multilayer ceramic body is cut such that ends of the first and second internal electrode patterns are alternately and respectively exposed to the side.

Then, the multilayer body chip is sintered at about 1,200° C. to form a sintered ceramic body. The surface of the sintered ceramic body is polished within a barrel containing water and a polishing medium. The surface polishing may be performed in the process of forming the multilayer ceramic body.

Then, the first and second external electrodes are formed to cover the sides of the sintered ceramic body and to be electrically connected to the first and second internal electrodes which are exposed to the sides of the sintered ceramic body.

Hereinafter, the process of forming the external electrodes will be described in detail.

First, a first powder and a second powder are prepared. The first powder includes copper and has a mean grain size of 3 μm or less, and the second powder has a lower diffusion speed and a higher melting point than the copper and has a mean grain size of 180 nm. A conductive paste for an external electrode is prepared by mixing the first powder, the second powder, and an organic binder.

The second powder may include one or more of Ni, Co, Fe, and Ti. Also, the second powder may use a powder type, an alloy type of the second powder and the copper, or a core-shell type in which the copper is coated with the second powder.

The second powder may have 0.01 to 30 wt % with respect to the first powder. When the second powder is less than 0.01 wt %, it is difficult to control the sintering speed. Thus, a blister or radial crack may be generated. When the second powder is greater than 30 wt %, the contact may become poor and the densification may be degraded.

The conductive paste for an external electrode is coated on the side of the sintered ceramic body to form first and second external electrode patterns. The conductive paste for an external electrode is sintered to form external electrodes. The sintering of the conductive paste for an external electrode may be performed at a temperature of 600 to 900° C.

Subsequently, the surfaces of the external electrodes may be plated with Ni or Sn.

In general, as the mean grain size of the powder is smaller, the contact characteristic and the densification are improved. However, as the mean grain size of the powder is smaller, the sintering initiation and sintering speed becomes faster. Thus, it is difficult to exhaust gas generated at high temperature, and a blister defect may be generated so that a gap between the sintered ceramic body and the external electrodes are widened.

In addition, the copper powders of the external electrodes are dominantly diffused to the internal electrodes in the contact region between the external electrodes and the internal electrodes during the sintering of the external electrodes. More specifically, the diffusion speed of copper toward nickel is faster than the diffusion speed of nickel toward copper, and is about 100 times at the sintering temperature of 780° C.

Therefore, during the sintering of the external electrodes, the copper powders of the external electrodes are dominantly diffused to the internal electrodes by the difference of the diffusion speed. Due to such diffusion, the contact region between the internal electrodes and the external electrodes expands to apply stress to the dielectric layer. The stress applied to the dielectric layer generates a crack. If a crack generated at the end of the chip propagates to the inside of the chip, the reliability of the multilayer ceramic capacitor is degraded.

However, according to the embodiment of the present invention, in the case of using the conductive paste for a external electrode, which includes the second powder having a lower diffusion speed and a higher melting point than the copper powder, the volume expansion of the internal electrodes due to the diffusion is suppressed. Hence, the occurrence of the radial crack may be prevented. Furthermore, the sintering speed may be controlled because the copper powder and the second powder form the isomorphous solid solution, thereby preventing the occurrence of the blister.

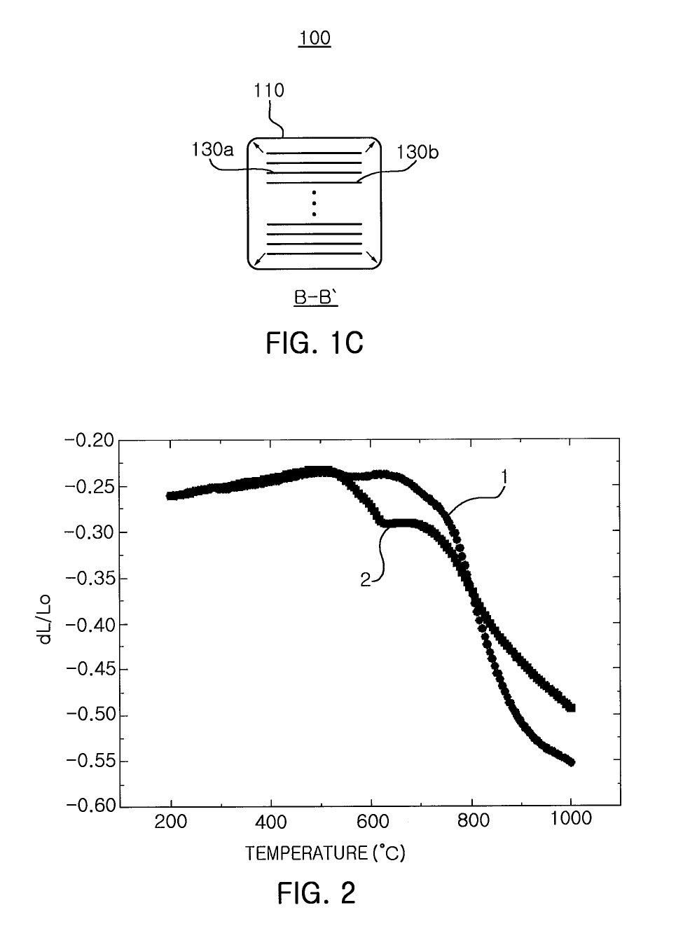

FIG. 2 is a sintering shrinkage curve of a paste for an external electrode including a copper powder and a nickel powder according to an embodiment of the present invention.

Referring to FIG. 2, in a case 1 where only the copper powder is included, the sintering shrinkage is rapidly progressed at a temperature of 650° C. or more. However, in a case 2 where the copper powder and the nickel powder are included, primary shrinkage begins at a temperature of 530° C. and a shrinkage generally occurs at a temperature of 600° C. or more.

The control of the copper diffusion speed by the addition of nickel makes it possible to sinter the external electrodes after sufficiently exhausting high-temperature gas generated from the original material during the sintering of the electrodes. Thus, the blister problem may be solved. Compared with the case where only the copper powder is used, the case where the nickel powder is added has a quick external electrode sintering start temperature but exhibits a general shrinkage behavior because of the influence of the isomorphous solid solution generated by a substitutional diffusion of nickel added to the copper powder.

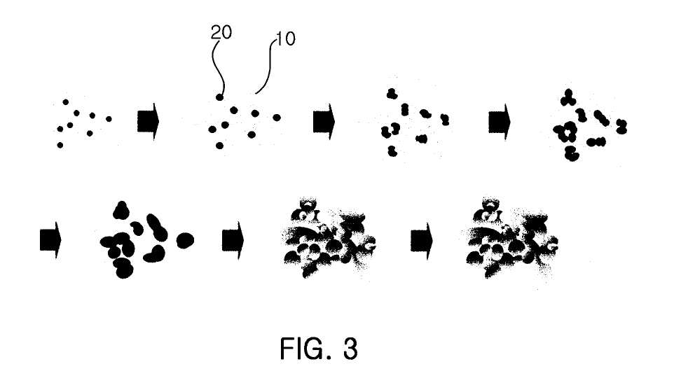

FIG. 3 is a schematic sintering behavior view explaining a mechanism in which the copper-nickel isomorphous solid solution suppresses the sintering speed of the external electrodes.

The paste for an external electrode to which the nickel powder is added generates the isomorphous solid solution from the region where a necking is formed by the contact between the nickel particle and the copper particle 10 while the sintering is performed between the fine nickel particle and the copper particle. Locally high Ni content has a pinning effect which suppresses the sintering behavior, and pores disappear as the time passes by. The melting point of nickel 20 is higher than that of copper 10 by about 370° C. Therefore, the copper-nickel isomorphous solid solution has a higher sintering temperature than copper, thus it is possible to control the sintering speed of the paste for an external electrode.

Under the conditions of Table 1 below, the paste for an external electrode and the multilayer ceramic capacitor including the same were manufactured. The radial crack and blister occurrence rates in the manufactured multilayer ceramic capacitor were measured.

TABLE 1

| | | | | | Radial | |
|---|---|---|---|---|---|---|
| | MSG of | MGS of | wt % of | | crack | Blister |
| | second | second | second | Cap. | occurrence | occurrence |
| | powder | powder | powder | (uF) | rate (%) | rate (%) |
| E 1 | 3.0 um | 180 nm | 3 | 1.12 | 0 | 0 |
| | Flake Cu | | | | | |
| E 2 | 3.0 um | 180 nm | 5 | 1.14 | 0 | 0 |
| | Flake Cu | | | | | |
| E 3 | 3.0 um | 180 nm | 6 | 1.11 | 0 | 0 |
| | Flake Cu | | | | | |
| E 4 | 3.0 um | 180 nm | 10 | 1.09 | 0 | 0 |
| | Flake Cu | | | | | |
| E 5 | 3.0 um | 180 nm | 20 | 0.97 | 0 | 0 |
| | Flake Cu | | | | | |
| E 6 | 1.0 um | 180 nm | 3 | 1.13 | 0 | 0 |
| | Spherical | | | | | |
| | Cu | | | | | |
| E 7 | 3.0 um | 180 nm | 3 | 1.07 | 0 | 0 |
| | Spherical | | | | | |
| | Cu | | | | | |
| C 1 | 3.0 um | — | — | 1.11 | 43 | 28 |
| | Flake Cu | | | | | |
| C 2 | 3.0 um | 300 nm | 3 | 1.12 | 8 | 0 |
| | Flake Cu | | | | | |
| C 3 | 3.0 um | 600 nm | 3 | 1.11 | 11 | 0 |
| | Flake Cu | | | | | |

Where “E” denotes “embodiment”, “C” denotes “comparative example”, “MGS” denotes “mean grain size”, and “Cap.” denotes “capacitance”.

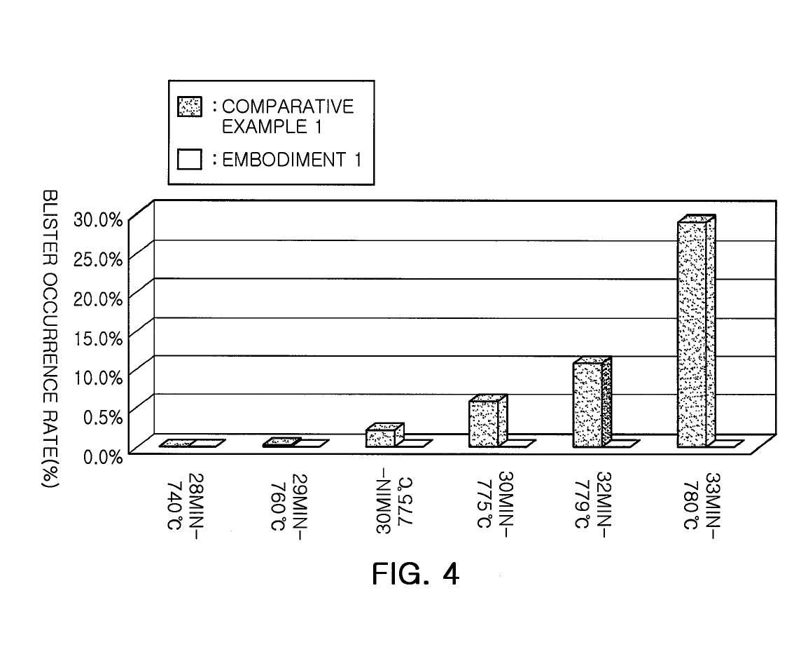

FIG. 4 is a graph showing the blister rates in the embodiment 1 and the comparative example 1. Referring to FIG. 4, in the case of the comparative example 1, the blister began to occur at a temperature of 740° C. or more which is the densification completion time confirmed in the fine structure analysis, and the blister occurrence frequency increased as the sintering temperature increased. However, in the case of the embodiment 1, no blister occurred in all temperature ranges where the sintering was performed.

In the conductive paste for an external electrode, the second powder having a lower diffusion speed and a higher melting point than the copper is added to the first powder including the copper and having a mean grain size of 3 μm or less, thereby obtaining the isomorphous solid solution including the copper and the second powder. Since the sintering speed of the external electrode becomes slow and the sintering temperature rises, a blister occurrence rate may be lowered. Moreover, since the diffusion from the external electrodes to the internal electrodes is suppressed, a radial crack occurrence rate by the volume expansion of the internal electrodes is lowered.

While the present invention has been shown and described in connection with the exemplary embodiments, it will be apparent to those skilled in the art that modifications and variations can be made without departing from the spirit and scope of the invention as defined by the appended claims.

What is claimed is:

1. A conductive paste compound for an external electrode, comprising:
a first powder including copper and having a mean grain size of 3 μm or less; and
a second powder having a lower diffusion speed and a higher melting point than the copper and having a mean grain size of 180 nm or less.

2. The conductive paste compound of claim 1, wherein the second powder comprises one or more material selected from the group consisting of nickel, cobalt, iron, and titanium.

3. The conductive paste compound of claim 1, wherein the second powder is a powder type, an alloy type of the second powder and the copper, or a core-shell type where the copper is coated with the second powder.

4. The conductive paste compound of claim 1, wherein the second powder is 0.01 to 30 wt % with respect to the first powder.

5. A multilayer ceramic capacitor comprising:
a sintered ceramic body;
a plurality of first and second internal electrodes provided inside the sintered ceramic body, the first and second internal electrodes having ends being alternately and respectively exposed to sides of the sintered ceramic body; and
first and second external electrodes provided inside the sintered ceramic body and electrically connected to the first and second internal electrodes, respectively,
wherein the first and second external electrodes are obtained by sintering a conductive paste which comprises a first powder including copper and having a mean grain size of 3 μm or less, and a second powder having a lower diffusion speed and a higher melting point than the copper and having a mean grain size of 180 nm or less, and
the first powder and the second powder form an isomorphous solid solution, and of which the porosity is 0.01% to 2.0%.

6. The multilayer ceramic capacitor of claim 5, wherein the second powder comprises one or more material selected from the group consisting of nickel, cobalt, iron, and titanium.

7. The multilayer ceramic capacitor of claim 5, wherein the second powder is a powder type, an alloy type of the second powder and the copper, or a core-shell type where the copper is coated with the second powder.

8. The multilayer ceramic capacitor of claim 5, wherein the second powder is 0.01 to 30 wt % with respect to the first powder.

9. A method for manufacturing a multilayer ceramic capacitor, comprising:
preparing a plurality of ceramic green sheets;
forming first and second internal electrode patterns on the ceramic green sheets;
forming a multilayer ceramic body by laminating the ceramic green sheets where the first and second internal electrode patterns are formed;
forming a sintered ceramic body by cutting the multilayer ceramic body such that ends of the first and second internal electrode patterns are alternately and respectively exposed, and sintering the cut multilayer ceramic body;
forming first and second external electrode patterns by using a conductive paste for an external electrode, such that the first and second external electrode patterns are electrically connected to the sides of the sintered ceramic body, wherein the conductive paste for an external electrode comprises a first powder including copper and having a mean grain size of 3 μm or less, and a second powder having a lower diffusion speed and a higher melting point than the copper and having a mean grain size of 180 nm or less; and
sintering the first and second external electrode patterns to form first and second external electrodes.

10. The method of claim 9, wherein the forming of the first and second external electrodes is performed at a temperature of 600 to 900° C.

11. The method of claim 9, wherein the second powder comprises one or more material selected from the group consisting of nickel, cobalt, iron, and titanium.

12. The method of claim 9, wherein the second powder is a powder type, an alloy type of the second powder and the copper, or a core-shell type where the copper is coated with the second powder.

13. The method of claim 9, wherein the second powder is 0.01 to 30 wt % with respect to the first powder.
